(19) United States
(12) Patent Application Publication
(10) Pub. No.: US 2016/0343166 A1
(43) Pub. Date: Nov. 24, 2016

(54) IMAGE-CAPTURING SYSTEM FOR COMBINING SUBJECT AND THREE-DIMENSIONAL VIRTUAL SPACE IN REAL TIME

(71) Applicant: TEAMLAB INC., Tokyo (JP)

(72) Inventor: Toshiyuki INOKO, Tokyo (JP)

(73) Assignee: TEAMLAB INC., Tokyo (JP)

(21) Appl. No.: 15/102,012

(22) PCT Filed: Dec. 22, 2014
(86) PCT No.: PCT/JP2014/083853

§ 371 Date: Aug. 12, 2016

(30) Foreign Application Priority Data
Dec. 24, 2013 (JP) 2013-264925

(51) Int. Cl. G06T 19/00; G06T 7/00; G06T 15/00

(52) U.S. Cl. CPC G06T 19/006; G06T 15/00; G06T 7/004; G06T 2207/10004; G06T 2207/20212; G06T 2207/30244

(57) ABSTRACT

[Problem] To generate a highly realistic composite image.

[Solution] This image-capturing system is provided with a camera (10) for capturing an image of a subject, a tracker (20) for detecting the position and orientation of the camera, a space image storage unit (30) in which an image of a three-dimensional virtual space is stored, and an image-forming unit (40) for generating a composite image in which an image of the subject captured using the camera and an image of the three-dimensional virtual space are combined. The image-forming unit (40) projects the three-dimensional virtual space specified by a world coordinate system (X, Y, Z) onto screen coordinates (U, V), in which the camera coordinate system (U, V, N) of the camera is taken as a reference, and combines the images of the three-dimensional virtual space and the subject on a screen specified by the screen coordinates (U, V). The camera coordinate system (U, V, N) is then set on the basis of the position and orientation of the camera detected by the tracker.

### TECHNICAL FIELD

The present invention relates to an image-capturing system for combining and outputting an image of a subject captured using a camera and a three-dimensional virtual space rendered using computer graphics in real time.

### BACKGROUND ART

Conventionally, generation of a composite image has been known, in which a camera and an image (including still image and moving image) are installed at fixed positions The same shall apply hereinafter as an image of a subject is captured, the image of the subject and a three-dimensional virtual space are combined (Patent Literature 1). Such composite image generation method, for example, is often used for producing TV programs.

### CITATION LIST

### Patent Literature

Patent Literature 1: JP H11-261888 A

### SUMMARY OF INVENTION

### Technical Problem

The conventional composite image generation method had to install the camera at a predetermined position and capture the image of the subject without moving the position of the camera in order to create the composite image of the subject and the three-dimensional virtual space. That is, in the conventional composite image generation technique, the position of the camera position (viewpoint) has to be fixed in a world coordinate system specifying the three-dimensional virtual space to render the composite image on a projection plane based on a camera coordinate system. For this reason, when the position of the camera (viewpoint) moves, the conventional technique has to reset camera coordinates after the movement in order to appropriately combine the subject and the three-dimensional virtual space.

Such necessity to reset the camera coordinate system for times when the position of the camera changes, it is difficult to continue to capture the subject, which can actively move beyond the capturing range of the camera. Therefore, in the conventional method, it is necessary to limit the movement of the subject when the composite image is generated. The fact that the position of the camera does not change means that a position and orientation of a background in the three-dimensional virtual space does not change at all. For this reason, the sense of reality and sense of immersion are lost and not obtained when the image of the subject is combined with a three-dimensional virtual space.

Therefore, the present invention aims to provide an image-capturing system capable of generating a highly realistic and immersive composite image. Specifically, the present invention provides the image-capturing system of the composite image that is capable of capturing the image of the subject continuously while changing the position and orientation of the camera and in which the background of the three-dimensional virtual space is changed in real time depending on the orientation of the camera.

### Solution to Problem

The inventor of the present invention, as a result of intensive studies about the solution to problems of the above conventional invention, has obtained findings that the images of the subject and the three-dimensional virtual space can be combined in real time by providing a tracker for detecting the position and orientation of the camera. The tracker specifies the position and orientation of the camera coordinate system in the world coordinate system. Then, the present inventor has conceived that the highly realistic and immersive composite image can be generated on the basis of the above findings, and has completed the present invention. Specifically, the present invention has the following configuration.

The present invention relates to an image-capturing system for combining the images of the subject and the three-dimensional virtual space in real time.

The image-capturing system of the present invention is provided with a camera 10, a tracker 20, a space image storage unit 30, and a rendering unit 40.

The camera 10 is a device for capturing the image of the subject. The tracker 20 is a device for detecting the position and orientation of the camera 10. The space image storage unit 30 stores the image of the three-dimensional virtual space. The rendering unit 40 generates the composite image, which combines the image of the subject captured using the camera 10 and the image of the three-dimensional virtual space stored in the space image storage unit 30. The rendering unit 40 projects the three-dimensional virtual space specified by the world coordinate system (X, Y, Z) onto screen coordinates (U, V), in which the camera coordinate system (U, V, N) of the camera is taken as a reference, and combines the images of the three-dimensional virtual space and the subject on a screen (UV plane) specified by the screen coordinates (U, V).

Here, the camera coordinate system U, V, N is set on the basis of the position and orientation of the camera 10 detected using the tracker 20.

As in the above configuration, by always grasping the position and orientation of the camera 10 using the tracker 20, it can grasp how the camera coordinate system (U, V, N) changes in the world coordinate system (X, Y, Z). That is, “position of the camera 10” corresponds to an origin of the camera coordinates in the world coordinate system to specify the three-dimensional virtual space. The orientation of the “camera 10” corresponds to the direction of each of the coordinate axes (U-axis, V-axis, N-axis) of the camera coordinate in the world coordinate system. For this reason, by grasping the position and orientation of the camera, viewing transformation (geometric transformation) can be performed from the world coordinate system, in which the three-dimensional virtual space exists, to the camera coordinate system. Therefore, by continuing to grasp the position and orientation of the camera, the images of the subject and the three-dimensional virtual space can be combined in real time even in a case where the orientation of the camera changes. Furthermore, the orientation of the background in the three-dimensional virtual space can also change depending on the orientation (camera coordinate system) of the camera. Therefore, a composite image with sense of reality, as if the subject actually existed in the three-dimensional virtual space, can be generated in real time.

The image-capturing system of the present invention is preferably further provided with a monitor 50. The monitor 50 is installed at a position visible from a person, who acts as a subject (subject person), whose image is captured by the camera 10. In this case, the rendering unit 40 outputs the composite image to the monitor 50.

As in the above configuration, by installing the monitor 50 at the position visible from a subject person, the monitor 50 can display the composite image of the subject person and the three-dimensional virtual space. The subject person can be subjected to image capturing while checking the composite image. For this reason, the subject person can experience as if the subject person exists in the three-dimensional virtual space. Thus, a highly immersive image-capturing system can be provided.

The image-capturing system of the present invention is preferably further provided with a motion sensor 60 and a content storage unit 70. The motion sensor 60 is a device for detecting motion of the subject person. The content storage unit 70 stores a content including an image in association with information relating to the motion of the subject. In this case, the rendering unit 40 preferably combines the content that is associated with the motion of the subject detected using the motion sensor 60 with the image of the three-dimensional virtual space and the image of the subject on a screen, and outputs the composite image of the content and the images to the monitor 50.

As in the above configuration, when the subject person strikes a particular pose, the motion sensor 60 will detect the motion. Depending on the pose, a content image will further combine with the three-dimensional virtual space and the image of the subject. For example, when the subject person strikes a pose of using magic, the magic corresponding to the pose is displayed as an effect image. Therefore, it is possible to give a sense of immersion to the subject person, as if the subject person entered the world of animation.

In the image-capturing system of the present invention, it is preferable that the rendering unit 40 performs calculation for obtaining both or any one of a distance from the camera 10 to the subject and an angle of the subject to the camera 10. For example, the rendering unit 40 is capable of obtaining the angle and distance from the camera 10 to the subject on the basis of the position and orientation of the camera 10 detected using the tracker 20, and the position of the subject specified using the motion sensor 60. The rendering unit 40 is also capable of obtaining the angle and distance from the camera 10 to the subject by analyzing the image of the subject captured using the camera 10. The rendering unit 40 may obtain the angle and distance from the camera 10 to the subject by using any one of the tracker 20 and the motion sensor 60.

The rendering unit 40 is capable of changing the content depending on the above calculation result. For example, the rendering unit 40 is capable of changing various conditions such as the size, position, orientation, color, number, display speed, display time, and transparency of the content. The rendering unit 40 may change the type of the content that is read from the content storage unit 70 and is displayed on the monitor 50, depending on the angle and distance from the camera 10 to the subject.

As in the above configuration, by changing the content depending on the angle and distance from the camera 10 to the subject, the content can be highly realistically displayed. For example, the sizes of the subject and the content can be matched with each other by displaying the content with a smaller size in a case in which the distance from the camera 10 to the subject is large, or by displaying the content with a larger size in a case in which the distance from the camera 10 to the subject is small. When the content of a large size is displayed in a case in which the distance between the camera 10 and the subject is small, it can prevent the subject from hiding behind the back of the content by increasing the transparency of the content so that the subject is displayed through the content.

The image-capturing system of the present invention may be further provided with a mirror type display 80. The mirror type display 80 is installed at a position visible from the subject being a human (subject person) whose image is being captured by the camera 10.

The mirror type display 80 includes a display 81 capable of displaying an image, and a semitransparent mirror 82 arranged at the display surface side of the display 81. The semitransparent mirror 82 transmits the light of the image displayed by the display 81, and reflects part or all of the light entering from an opposite side of the display 81.

As in the above configuration, by arranging the mirror type display 80 at a position visible from the subject person and displaying the image on the mirror type display 80, sense of presence and sense of immersion can be enhanced. In addition, for example, by displaying a sample of a pose or a sample of a dance on the mirror type display 80, the subject person can effectively perform practice since the subject person can compare his or her pose or dance with the sample.

The image-capturing system of the present invention may be further provided with a second rendering unit 90. The second rendering unit 90 outputs the image of the three-dimensional virtual space stored in the space image storage unit 30 to the display 81 of the mirror type display 80. Incidentally, here, for descriptive purpose, the rendering unit (first rendering unit) 40 and the second rendering unit 90 are distinguished from each other; however, both units may be configured by the same device, and may be configured by different devices.

Here, the second rendering unit 90 projects the three-dimensional virtual space specified by the world coordinate system (X, Y, Z) onto the screen coordinates (U, V), in which the camera coordinate system (U, V, N) of the camera is taken as the reference. The camera coordinate system (U, V, N) is then set on the basis of the position and orientation of the camera detected using the tracker 20.

As in the above configuration, the captured image of the subject using the camera 10 is not displayed on the display 81; however, the three-dimensional virtual space image is displayed, in which the camera coordinate system (U, V, N) is taken as a reference depending on the position and orientation of the camera 10. For this reason, the three-dimensional virtual space image displayed on the monitor 50 and the three-dimensional virtual space image displayed on the display 81 can be matched with each other to some extent. That is, the background of the three-dimensional virtual space image displayed on the mirror type display 80 can also be changed depending on the real position and orientation of the camera 10, so that sense of presence can be enhanced.

In the image-capturing system of the present invention, the second rendering unit 90 may read the content that is associated with the motion of the subject detected using the motion sensor 60 from the content storage unit 70 and output the content to the display 81.

As in the above configuration, for example, when the subject person strikes a particular pose, the content corresponding to the pose is also displayed in the mirror type display 80. Thus, greater sense of immersion can be provided to the subject.

### Advantageous Effects of Invention

The image-capturing system of the present invention is capable of continuing to capture the image of the subject while changing the position and orientation of the camera, and changing the background of the three-dimensional virtual space in real time depending on the orientation of the camera. Therefore, with the present invention, a highly realistic and immersive composite image can be provided.

### BRIEF DESCRIPTION OF DRAWINGS

FIG. 1 illustrates an overview of an image-capturing system according to the present invention. FIG. 1 is a perspective view schematically illustrating an example of an image capturing studio provided with the image-capturing system.

FIG. 2 is a block diagram illustrating an example of a configuration of the image-capturing system according to the present invention.

FIG. 3 is a schematic diagram illustrating a concept of a coordinate system in the present invention.

FIG. 4 illustrates a display example of a monitor of the image-capturing system according to the present invention.

FIG. 5 is a plan view illustrating an equipment arrangement example of the image capturing studio.

### DESCRIPTION OF EMBODIMENTS

Hereinafter, embodiments of the present invention are described with reference to the drawings. The present invention is not limited to the embodiments described below, and includes those appropriately modified from the embodiments below within the scope that is obvious to those skilled in the art.

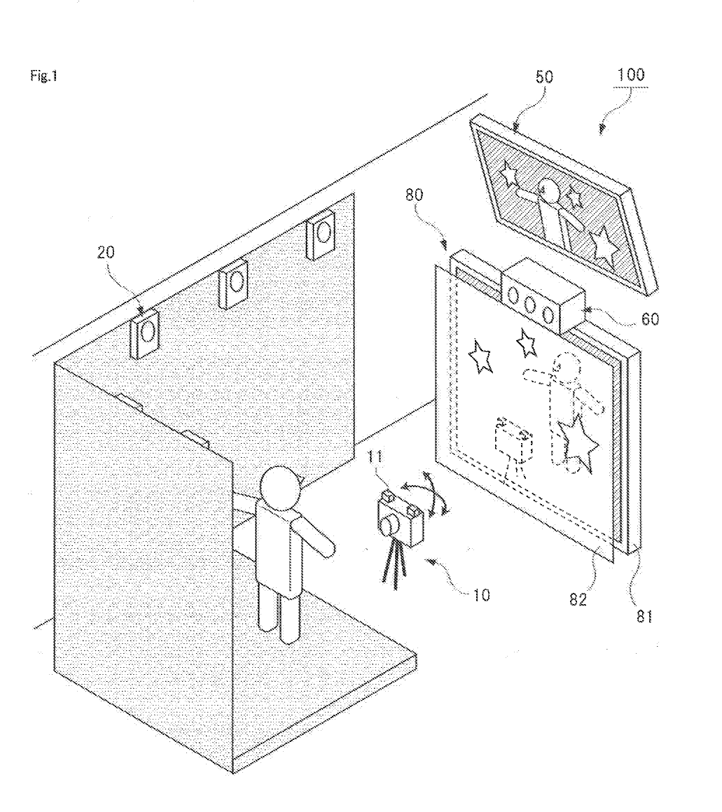

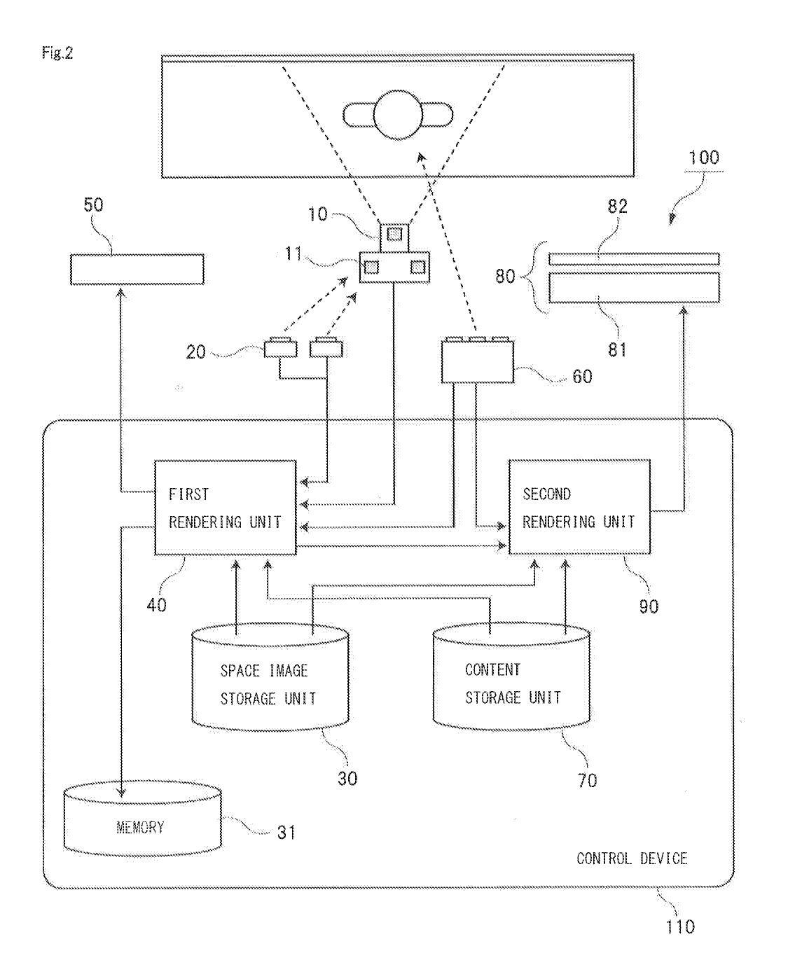

FIG. 1 illustrates an example of an image capturing studio provided with an image-capturing system 100 according to the present invention. FIG. 2 illustrates a block diagram of the image-capturing system 100 according to the present invention. As illustrated in FIG. 1 and FIG. 2, the image-capturing system 100 is provided with a camera 10 for capturing an image of a subject. The “image” used herein may be a still image and/or a moving image. As for the camera 10, a known camera may be used that is capable of capturing the still image and/or the moving image. In the image-capturing system of the present invention, the camera 10 is capable of freely changing an image capturing position and/or image capturing orientation of the subject. For this reason, an arrangement position of the camera 10 does not have to be fixed.

As illustrated in FIG. 1, a human subject is preferable. In the present application, the subject being a human is referred to as a “subject person.” For example, the subject person acts as a model on a stage. The stage has a color that facilitates image combining processing, such as the color generally referred to as a green back or a blue back.

The image-capturing system 100 is provided with a plurality of trackers 20 for detecting the position and orientation of the camera 10. As illustrated in FIG. 1, the trackers 20 are fixed at positions that are the upper sides of the studio and in which the camera 10 can be captured. It is preferable that at least two or more trackers 20 capture the position and orientation of the camera 10 at all times. In the present invention, the position and orientation of the camera 10 are grasped from a relative positional relationship between the camera 10 and the trackers 20. For this reason, if the positions of the trackers 20 are moved, the position and orientation of the camera 10 cannot be appropriately grasped. For this reason, in the present invention, the trackers 20 should be in fixed positions.

As for the trackers 20, known devices which detect a position and motion of an object can be used. As the trackers 20, devices of known method can be used, such as an optical type, magnetic type, video type, and mechanical type. The optical type specifies the position and motion of the object by emitting a plurality of laser beams to the object (camera) and detecting the reflected light. The trackers 20 of the optical type are also capable of detecting the reflected light from a marker attached to the object. The magnetic type specifies the position and motion of the object by installing the plurality of markers to the object and grasping the positions of the markers using a magnetic sensor. The video type specifies the motion of the object by analyzing a picture of the object captured using a video camera and taking in the picture as a 3D motion file. The mechanical type specifies the motion of the object on the basis of a detection result of a sensor such as a gyro sensor and/or an acceleration sensor attached to the object. The position and orientation of the camera for capturing the image of the subject can be grasped by any of the above methods. In the present invention, in order to detect the position of the camera 10 fast and appropriately, it is preferable that a marker 11 is attached to the camera 10 and the marker 11 is tracked using the plurality of trackers 20.

As illustrated in FIG. 2, the camera 10 acquires the image of the subject (subject person), and the plurality of trackers 20 acquires information relating to the position and orientation of the camera 10. The image captured using the camera 10 and the information of the position and orientation of the camera 10 detected using the trackers 20 are input to a first rendering unit 40.

The first rendering unit 40 is basically a function block for performing rendering processing in which the image of the subject captured using the camera 10 is combined in real time with the image of the three-dimensional virtual space generated using computer graphics. As illustrated in FIG. 2, the first rendering unit 40 is realized with a part of a device configuring a control device 110 such as a personal computer (PC). Specifically, the first rendering unit 40 can be configured with a central processing unit (CPU) or a graphics processing unit (GPU) provided in the control device 11.

The first rendering unit 40 reads the image of the three-dimensional virtual space for combining with the image of the subject, from a space image storage unit 30. In the space image storage unit 30, one type or a plurality of types of images of three-dimensional virtual space are stored. The three-dimensional virtual space can generate a wide variety of backgrounds such as the outdoor, indoor, sky, sea, forest, space, and fantasy world in advance using computer graphics and stored in the space image storage unit 30. In the space image storage unit 30, besides these backgrounds, a plurality of objects may be stored that exists in the three-dimensional virtual space. The objects are three-dimensional images such as characters, graphics, buildings, and natural objects to be arranged in the three-dimensional space, and are generated in advance using known CG processing such as polygon, and stored in the space image storage unit 30. In FIG. 1, star-shaped objects are illustrated as an example.

The first rendering unit 40 reads the image of the three-dimensional virtual space from the space image storage unit 30, and determines the actual position and orientation of the camera 10 in the world coordinate system (X, Y, Z) for specifying the three-dimensional virtual space. At that time, the first rendering unit 40 refers to the information relating to the actual position and orientation of the camera 10 detected using the plurality of trackers 20. That is, the camera 10 has a unique camera coordinate system (U, V, N). Therefore, the first rendering unit 40 performs processing for setting the camera coordinate system (U, V, N) in the world coordinate system (X, Y, Z) on the basis of the information relating to the actual position and orientation of the camera 10 detected using the trackers 20.

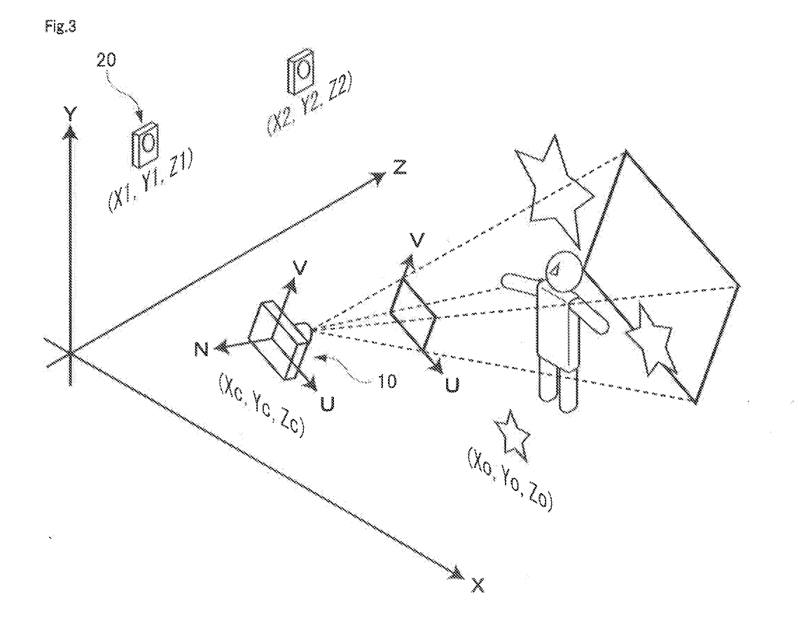

Specifically, a relationship between the world coordinate system (X, Y, Z) and the camera coordinate system (U, V, N) is schematically illustrated in FIG. 3. The world coordinate system has the X-axis, Y-axis, and Z-axis perpendicular to each other. The world coordinate system (X, Y, Z) specifies a coordinate point in the three-dimensional virtual space. In the three-dimensional virtual space, one or more objects (example: star-shaped object) exist. Each object is arranged at a unique coordinate point (Xo, Yo, Zo) in the world coordinate system. The system of the present invention is provided with the plurality of trackers 20. The position to which each of the trackers 20 is attached is known, and the coordinate point of each of the trackers 20 is specified by the world coordinate system (X, Y, Z). For example, the coordinate points of the trackers 20 are represented by (X1, Y1, Z1) and (X2, Y2, Z2).

The camera 10 has the unique camera coordinate system (U, V, N). In the camera coordinate system (U, V, N), when viewed from the camera 10, the horizontal direction is the U-axis, the vertical direction is the V-axis, and the depth direction is the N-axis. These U-axis, V-axis, and N-axis are perpendicular to each other. A two-dimensional range of a screen captured by the camera 10 is a screen coordinate system (U, V). The screen coordinate system indicates a range of the three-dimensional virtual space displayed on a display device such as a monitor or a display. The screen coordinate system (U, V) corresponds to the U-axis and the V-axis of the camera coordinate system. The screen coordinate system (U, V) is a coordinate after applying projective transformation (perspective transformation) to a space captured using the camera 10.

The first rendering unit 40 projects the three-dimensional virtual space specified by the world coordinate system (X, Y, Z) onto screen coordinates (U, V), in which the camera coordinate system (U, V, N) of the camera 10 is taken as a reference. The camera 10 cuts out a part of the three-dimensional virtual space in the world coordinate system (X, Y, Z) and displays the part on the screen. For this reason, a space of a capturing range of the camera 10 is a range that is separated by a front clipping plane and a rear clipping plane, and is referred to as view volume (view frustum). A space belonging to the view volume is cut out and is displayed on the screen specified by the screen coordinates (U, V). The object exists in the three-dimensional virtual space. The object has a unique depth value. The coordinate point (Xo, Yo, Zo) in the world coordinate system of the object is transformed into the camera coordinate system (U, V, N) when entering the view volume (capturing range) of the camera 10. When the plane coordinates (U, V) of the image of the subject and the object overlap with each other in the camera coordinate system (U, V, N), the image of a depth value (N) of the near side is displayed on the screen and hidden surface removal is performed on the far side of the image of a depth value (N).

The first rendering unit 40 combines the image of the three-dimensional virtual space and the image of the subject (subject person) actually captured by the camera 10 on the screen specified by the screen coordinates (U, V). However, at that time, it is necessary to specify the position (origin) and orientation of the camera coordinate system (U, V, N) in the world coordinate system (X, Y, Z), as illustrated in FIG. 3. Therefore, in the present invention, the position and orientation of the camera 10 is detected using the trackers 20, which have its own coordinate point in the world coordinate system (X, Y, Z). From a relative relationship between the camera 10 and the trackers 20, the position and orientation of the camera 10 in the world coordinate system (X, Y, Z) is specified.

Specifically, the plurality of trackers 20 each detects the positions of a plurality of measurement points (for example, marker 11) of the camera 10. For example, in the example illustrated in FIG. 2, three markers 11 are attached to the camera 10. By attaching three or more (at least two or more) markers 11 to the camera 10, it becomes easy to grasp the orientation of the camera 10. The positions of the markers 11 attached to the camera 10 in this way are detected using the plurality of trackers 20. Each of the trackers 20 has a coordinate point in the world coordinate system (X, Y, Z), and the coordinate point of each of the trackers 20 is known. For this reason, by detecting the positions of the markers 11 of the camera 10 using the plurality of trackers 20, the coordinate point in the world coordinate system (X, Y, Z) of each of the markers 11 can be specified using a simple algorithm such as triangulation. When the coordinate point in the world coordinate system (X, Y, Z) of each of the markers 11 is determined, the coordinate point and orientation in the world coordinate system (X, Y, Z) of the camera 10 can be specified on the basis of the coordinate point of each of the markers 11. When the coordinate point and orientation in the world coordinate system (X, Y, Z) of the camera 10 is determined, the camera coordinate system (U, V, N) can be set on the basis of the coordinate point and orientation. Thus, it is possible to specify a relative positional relationship of the camera coordinate system (U, V, N) in the world coordinate system (X, Y, Z) on the basis of the information of the position and orientation of the camera 10 detected using the trackers 20. For example, as illustrated in FIG. 3, the coordinates of the origin of the camera coordinate system (U, V, N) is (Xc, Yc, Zc) in the world coordinate system (X, Y, Z). Therefore, by detecting the position and orientation of the camera 10 using the trackers 20, it is possible to continue grasping in real time the camera coordinate system (U, V, N) in the world coordinate system (X, Y, Z) even in a case in which the position and orientation of the camera 10 is changed.

In this way, the first rendering unit 40 performs viewing transformation (geometric transformation) to transform the three-dimensional virtual space defined on the world coordinate system into the camera coordinate system. The fact that the position of the camera 10, which is defined on the world coordinate system, changes in the three-dimensional virtual space means that the position of the camera coordinate system to the world coordinate system has changed. For this reason, the first rendering unit 40 performs viewing transformation processing from the world coordinate system to the camera coordinate system for each time when different orientation of the camera 10 is specified using the trackers 20.

The first rendering unit 40 can eventually combine the image of the three-dimensional virtual space and the image of the subject captured by using the camera 10 on the two-dimensional screen specified by the screen coordinates (U, V) by obtaining the relative positional relationship between the world coordinate system (X, Y, Z) and the camera coordinate system (U, V, N) as described above. That is, when the subject (subject person) belongs to the view volume of the camera 10, a part or entirety of the subject is displayed on the screen. In addition, an object image and a background image of the three-dimensional virtual space reflected in the view volume of the camera 10 are displayed on the screen. Thus, by performing image combining, an image in which the subject exists in the background of the three-dimensional virtual space can be obtained. In a case in which the object existing in the three-dimensional virtual space exists in the front side of the image of the subject in the camera coordinate system (U, V, N) during image combining, hidden surface removal is performed to a part or entirety of the image of the subject. In a case in which the subject exists in front of the object, hidden surface removal is performed to a part or entirety of the object.

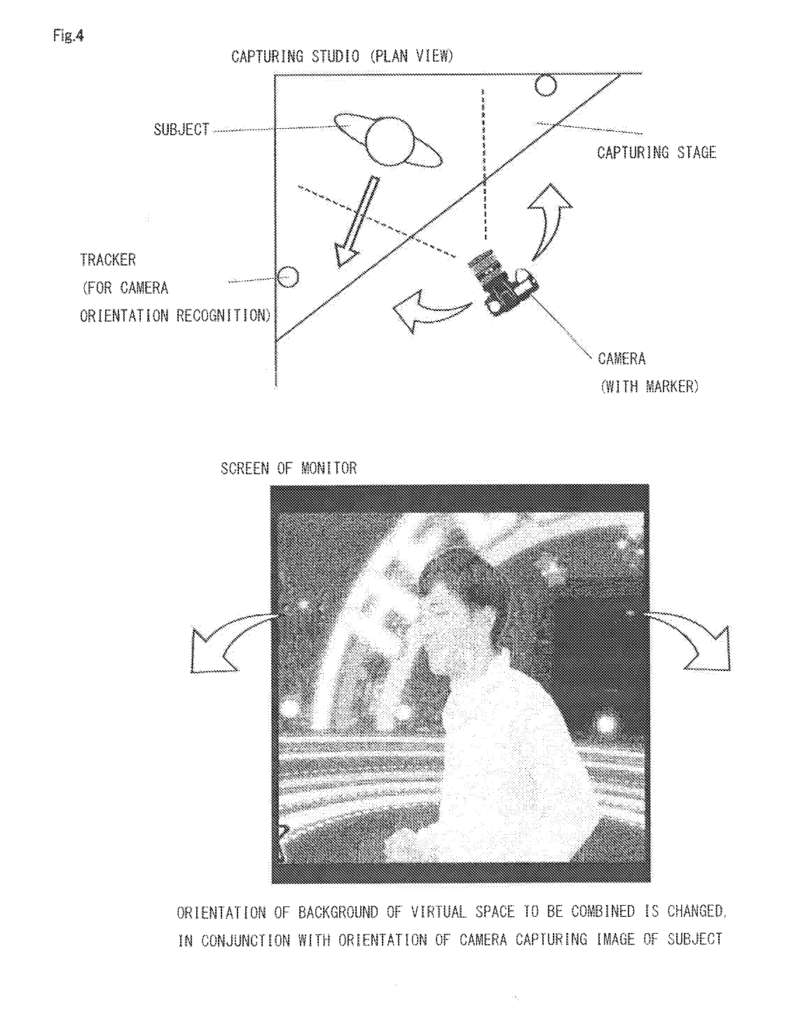

In FIG. 4, an example of the composite image generated by the image-capturing system 100 of the present invention is illustrated. For example, as illustrated in FIG. 4, in a case in which the subject moves around in the stage for image capturing, it is necessary to move the position of the camera 10 according to the movement of the subject in order to continue capturing the subject in the capturing range of the camera 10. At a where the image of the subject of the three-dimensional virtual space is displayed by combining images in real time, if the background image of the three-dimensional virtual space does not change depending on the position and orientation of the camera 10, a very unnatural composite image (video picture) will be generated. Therefore, in the present invention, as described above, the position and orientation of the camera 10 are continuously detected at all times using the plurality of trackers 20. As for the background image of the three-dimensional virtual space, the combined layers of the background image and the subject can change depending on the position and orientation of the camera 10. Thus, it is possible to combine the captured image of the subject with the background image in real time while changing the background image depending on the position and orientation of the camera 10. Therefore, it is possible to obtain a highly immersive composite image as if the subject entered the three-dimensional virtual space.

As illustrated in FIG. 2, the first rendering unit 40 outputs the composite image generated as described above to the monitor 50. The monitor 50 is arranged at a position visible from the subject (subject person) whose image is being captured by the camera 10, as illustrated in FIG. 1. The monitor 50 displays the composite image generated by the first rendering unit 40 in real time. For this reason, the person in charge of the monitor 50 can observe the subject person, who is walking around in the three-dimensional virtual space, and experience the wonders along with the subject person. In the present invention, the camera 10 can be moved to follow the subject person, and the background of the composite image can change depending on the position and orientation of the camera 10. Therefore, the sense of presence can be enhanced. In addition, the subject person can immediately check what kind of composite image is generated by checking the monitor 50.

As illustrated in FIG. 2, the first rendering unit 40 is also capable of outputting the composite image to a memory 31. The memory 31 is a storage device for storing the composite image and, for example, may be an external storage device that can be detached from the control device 110. The memory 31 may be an information storage medium such as a CR or DVD. Thus, the composite image can be stored in the memory 31, and the memory 31 can be passed to the subject person.

As illustrated in FIG. 2, the image-capturing system 100 may further include a motion sensor 60 and a content storage unit 70. The motion sensor 60 is a device for detecting motion of the subject (subject person). As illustrated in FIG. 1, the motion sensor 60 is installed at a position in which motion of the subject person can be specified. As the motion sensor 60, a device of known method can be used, such as an optical type, magnetic type, video type, or mechanical type. The method for detecting motion of the object may be the same, and may be different, between the motion sensor 60 and the trackers 20. The content storage unit 70 stores a content including an image in association with information relating to the motion of the subject person. The content stored in the content storage unit 70 may be a still image, a moving image, or a polygon image. The content may be information relating to sound such as music or voice. A plurality of contents is stored in the content storage unit 70, and each of the contents is associated with the information relating to the motion of the subject person.

As illustrated in FIG. 2, when the subject person strikes a particular motion (pose), the motion sensor 60 detects the motion of the subject person, and transmits the detected motion information to the first rendering unit 40. The first rendering unit 40, upon receiving motion information, searches the content storage unit 70 on the basis of the motion information. Thus, the first rendering unit 40 reads a particular content that is associated with the motion information from the content storage unit 70. The first rendering unit 40 combines the content read from the content storage unit 70 with the image of the subject person captured using the camera 10 and the image of the three-dimensional virtual space, and generates the composite image of the content and the images. The composite image generated by the first rendering unit 40 is output to the monitor 50 or the memory 31. Thus, depending on the motion of the subject person, the content corresponding to the motion can be displayed on the monitor 50 in real time. For example, when the subject person strikes a pose of chanting magic words, an effect image of the magic corresponding to the magic words is rendered on the three-dimensional virtual space. Thus, the subject person can obtain a sense of immersion as if the subject person entered the world (three-dimensional virtual space) where magic can be used.

The first rendering unit 40 may perform calculation for obtaining a distance from the camera 10 to the subject person and an angle of the subject person to the camera 10, and may perform processing for changing the content on the basis of the calculation result such as the obtained distance and angle. For example, the first rendering unit 40 is capable of obtaining the angle and distance from the camera 10 to the subject person on the basis of the position and orientation of the camera 10 detected using the trackers 20, and the position and orientation of the subject person specified using the motion sensor 60. The first rendering unit 40 is also capable of obtaining the angle and distance from the camera 10 to the subject by analyzing the image of the subject person captured using the camera 10. The rendering unit 40 may obtain the angle and distance from the camera 10 to the subject by using any one of the motion sensor 60 and the trackers 20. After that, the first rendering unit 40 changes the content depending on the above calculation result. For example, the first rendering unit 40 is capable of changing various conditions such as the size, position, orientation, color, number, display speed, display time, and transparency of the content. The first rendering unit 40 is also capable of changing the type of the content that is read from the content storage unit 70 and is displayed on the monitor 50, depending on the angle and distance from the camera 10 to the subject.

By adjusting display conditions of the content according to the angle and distance from the camera 10 to the subject person as described above, the content can be displayed highly realistically. For example, the size of the subject person and the content can be matched with each other by displaying the content with a smaller size in a case in which the distance from the camera 10 to the subject person is large, or by displaying the content with a larger size in a case in which the distance from the camera 10 to the subject person is small. When the content of a large size is displayed in a case in which the distance between the camera 10 and the subject person is small, it can prevent the subject from hiding behind the back of the content by increasing the transparency of the content so that the subject is displayed through the content. In addition, for example, it is also possible to recognize the position of the hand of the subject person using the camera 10 or the motion sensor 60, and to display the content according to the position of the hand.

As illustrated in FIG. 1, the image-capturing system 100 is preferably further provided with a mirror type display 80. The mirror type display 80 is installed at a position visible from the subject person whose image is being captured by the camera 10. More specifically, the mirror type display 80 is arranged at a position in which the mirror image of the subject person can be viewed from the subject person.

As illustrated in FIG. 1 and FIG. 2, the mirror type display 80 is configured with a display 81 which is capable of displaying an image, and a semitransparent mirror 82 arranged at a display surface side of the display 81. The semitransparent mirror 82 transmits the light of the image displayed by the display 81 and reflects the light entering from an opposite side of the display 81. For this reason, the subject person, when standing in front of the mirror type display 80, will simultaneously view the image displayed by the display 81 and the mirror image of the subject person reflected by the semitransparent mirror 82. For this reason, by displaying a sample picture of a dance or a pose using the display 81, the subject person can perform practice of the dance or the pose while comparing the sample picture with the appearance of the subject reflected by the semitransparent mirror 82. It is also possible to detect motion (pose or dance) of the subject person using the motion sensor 60 to perform scoring of the motion. For example, the control device 110 analyzes the motion of the subject person detected using the motion sensor 60, and performs calculation for obtaining a degree of confidence with the sample pose or dance. Thus, a numerical value is expressed to determine the improvement of the pose or dance of the subject person.

As illustrated in FIG. 2, the image-capturing system 100 may include a second rendering unit 90 for generating an image to be displayed on the display 81 of the mirror type display 80. In the example illustrated in FIG. 2, the second rendering unit 90 generates an image to be displayed on the display 81; on the other hand, the first rendering unit 40 generates an image to be displayed on the monitor 50. For this reason, since the first rendering unit 40 and the second rendering unit 90 have different functions from each other, the rendering units are illustrated as separate function blocks in FIG. 2. However, the first rendering unit 40 and the second rendering unit 90 may be configured with the same device (CPU or GPU). The first rendering unit 40 and the second rendering unit 90 may be configured with separate devices.

The second rendering unit 90 basically reads the images (background and object) of the three-dimensional virtual space from the space image storage unit 30, and displays the images on the display 81. At this time, the image of the three-dimensional virtual space to be displayed on the display 81 by the second rendering unit 90 is preferably the same type as the image of the three-dimensional virtual space to be displayed on the monitor 50 by the first rendering unit 40. Thus, the subject person simultaneously viewing the monitor 50 and the display 81 sees the same three-dimensional virtual space, so that the subject person can obtain an intense sense of immersion. In particular, as illustrated in FIG. 1, the semitransparent mirror 82 is installed in front of the display 81, and the subject person can experience as if the appearance of the subject reflected in the semitransparent mirror 82 entered the three-dimensional virtual space that is displayed on the display 81. Thus, by displaying the same image of the three-dimensional space on the monitor 50 and the display 81, it is possible to give greater sense of presence to the subject person.

As illustrated in FIG. 1, it is preferable that the image of the subject person captured using the camera 10 is not displayed on the display 81. That is, since the semitransparent mirror 82 is installed in front of the display 81, the subject person can see the appearance of the subject person reflected in the semitransparent mirror 82. If the image captured using the camera 10 is displayed on the display 81, the image of the subject person and the mirror image are seen to be overlapped each other, and sense of presence is rather impaired. However, the image of the subject person captured using the camera 10 is displayed on the monitor 50, so that the subject person can sufficiently check what kind of composite image is generated.

The second rendering unit 90 projects the three-dimensional virtual space specified by the world coordinate system (X, Y, Z) onto the screen coordinates (U, V), in which the camera coordinate system (U, V, N) of the camera 10 is taken as the reference, and then outputs the image of the three-dimensional virtual space specified by the screen coordinates (U, V) to the display 81. The camera coordinate system (U, V, N) of the camera 10 is then set on the basis of the position and orientation of the camera 10 detected using the trackers 20. That is, the second rendering unit 90 displays the image of the three-dimensional virtual space in a range that is captured using the camera 10 on the display 81.

As illustrated in FIG. 2, detection information from each of the trackers 20 is transmitted to the first rendering unit 40, and the first rendering unit 40 sets the camera coordinate system (U, V, N) of the camera 10 in the world coordinate system (X, Y, Z) on the basis of the detection information. Therefore, the first rendering unit 40 sends information relating to a position of the camera coordinate system (U, V, N) in the world coordinate system (X, Y, Z) to the second rendering unit 90. The second rendering unit 90 generates the image of the three-dimensional virtual space to be output to the display 81 on the basis of the information relating to the position of the camera coordinate system (U, V, N) in the world coordinate system (X, Y, Z). Thus, the same image of the three-dimensional virtual space is displayed on the monitor 50 and the display 81. As described above, when a viewpoint position of the camera 10 changes, the image of the three-dimensional virtual space displayed on the monitor 50 also changes. A similar phenomenon can be realized also on the display 81 when the viewpoint position of the camera 10 moves, the image of the three-dimensional virtual space displayed on the display 81 is changed along with the movement. In this way, by also changing the image on the display 81 of the mirror type display 80, it is possible to provide an experience with greater sense of presence to the subject person.

As illustrated in FIG. 2, the second rendering unit 90, similar to the first rendering unit 40, may read the content that is related to the motion of the subject person detected using the motion sensor 60 from the content storage unit 70 and output the content to the display 81. Thus, the content such as the effect image that is related to the motion of the subject person can be displayed not only on the monitor 50, but also on the display 81 of the mirror type display 80.

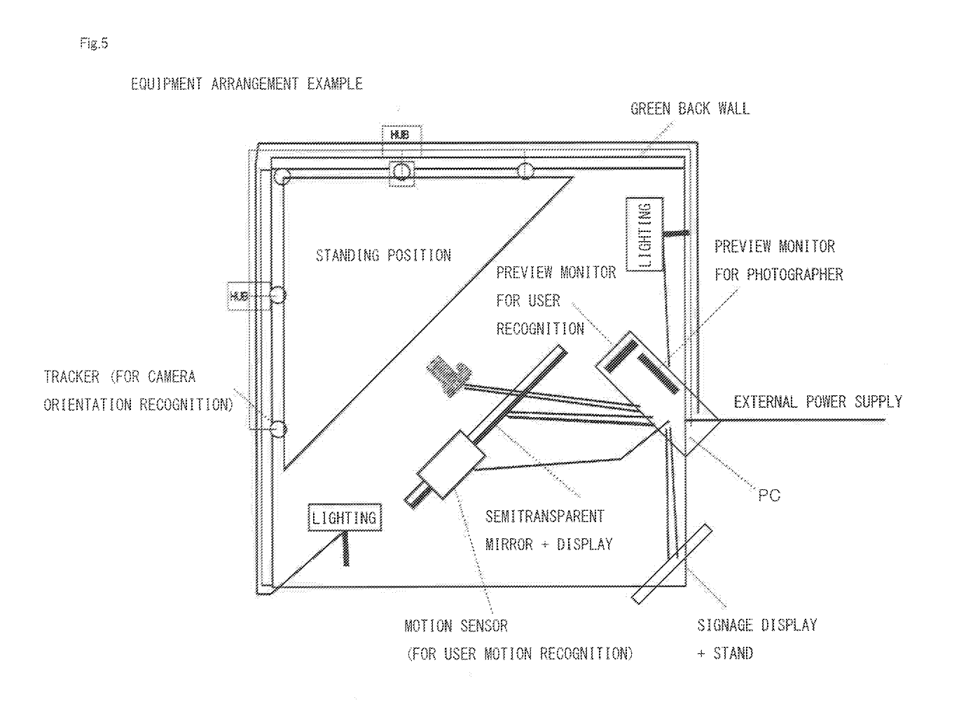

FIG. 5 is a plan view illustrating an arrangement example of equipment configuring the image-capturing system 100 of the present invention. It is preferable to build an image capturing studio, and arrange the equipment configuring the image-capturing system 100 in the studio, as illustrated in FIG. 5. However, FIG. 5 only illustrates an example of the arrangement of the equipment, and the image-capturing system 100 of the present invention is not limited to the system illustrated.

As described above, in the present application, in order to represent the content of the present invention, the description has been made of the embodiments of the present invention with reference to the drawings. However, the present invention is not limited to the above embodiments, and includes modifications and improvements that are based on items described in the present application and are obvious to those skilled in the art.

### INDUSTRIAL APPLICABILITY

The present invention relates to an image-capturing system for combining a subject and a three-dimensional virtual space in real time. The image-capturing system of the present invention can be suitably used in, for example, a studio for capturing images of photos and videos.

### REFERENCE SIGNS LIST

10 Camera
11 Marker
20 Tracker
30 Space image storage unit
31 Memory
40 First rendering unit
50 Monitor
60 Motion sensor
70 Content storage unit
80 Mirror type display
81 Display
82 Semitransparent mirror
90 Second rendering unit
100 Image-capturing system
110 Control device

1. An image-capturing system comprising:
a camera for capturing an image of a subject;
a tracker for detecting a position and orientation of the camera;
a space image storage unit in which an image of a three-dimensional virtual space is stored; and
a rendering unit for generating a composite image in which the image of the subject captured using the camera and the image of the three-dimensional virtual space stored in the space image storage unit are combined,
wherein the rendering unit
projects the three-dimensional virtual space specified by a world coordinate system (X, Y, Z) onto screen coordinates (U, V), in which a camera coordinate system (U, V, N) of the camera is taken as a reference, and
combines the images of the three-dimensional virtual space and the subject on a screen specified by the screen coordinates (U, V), and
the camera coordinate system (U, V, N) is set on the basis of the position and orientation of the camera detected using the tracker.

2. The image-capturing system according to claim 1, further comprising
a monitor installed at a position visible from the subject being a human whose image is being captured by the camera,
wherein the rendering unit outputs the composite image to the monitor.

3. The image-capturing system according to claim 2, further comprising:
a motion sensor for detecting motion of the subject; and
a content storage unit in which a content including an image is stored in association with information relating to the motion of the subject,
wherein the rendering unit combines the content that is associated with the motion of the subject detected using the motion sensor with the image of the three-dimensional virtual space and the image of the subject on the screen, and outputs a composite image of the content and the images to the monitor.

4. The image-capturing system, according to claim 3, changes the content depending on the calculation result, which is obtained from the rendering unit that obtains both or any one of a distance from the camera to the subject and an angle of the subject.

5. The image-capturing system according to claim 1, comprises of a mirror type display installed at a position visible from the subject being a human whose image is being captured by the camera,
wherein the mirror type display includes:
a display capable of displaying an image; and
a semitransparent mirror arranged at a display surface side of the display for transmitting light of the image displayed by the display and for reflecting light entering from an opposite side of the display.

6. The image-capturing system, according to claim 5, outputs the image of the three-dimensional virtual space stored in the space image storage unit to the display, and comprises of
a second rendering unit that projects the three-dimensional virtual space specified by the world coordinate system (X, Y, Z) onto the screen coordinates (U, V), which uses the reference from the camera coordinate system (U, V, N) that is set based on the position and orientation of the camera detected using the tracker.

7. The image-capturing system according to claim 5,
wherein the second rendering unit reads the content that is associated with the motion of the subject detected using the motion sensor from the content storage unit, and outputs the content to the display.
